(19) United States
(12) Patent Application Publication
(10) Pub. No.: US 2011/0067675 A1
(43) Pub. Date: Mar. 24, 2011

(54) FUEL INJECTION ASSEMBLY WITH OPTIMIZED HEAT COUPLING BETWEEN FUEL INJECTION DEVICE AND CYLINDER HEAD

(76) Inventors: Bernd Streicher, Filderstadt (DE); Dietmar Zeh, Tamm (DE); Thomas Pauer, Freiberg (DE)

(21) Appl. No.: 12/874,377

(22) Filed: Sep. 2, 2010

(30) Foreign Application Priority Data
Sep. 2, 2009 (DE) 10 2009 029 088.5

(51) Int. Cl. F02M 61/14

(52) U.S. Cl. 123/470

(57) ABSTRACT

A fuel injection assembly of an internal combustion engine, has an fuel injector for injecting fuel into a combustion chamber of the engine. The fuel injector is built into a cylinder head of the engine and there is an annular gap provided between the fuel injector and the cylinder head, or its attached hood. According to the invention, the gap is filled at least partially, preferably entirely, with a heat-conducting liquid whose thermal conductivity is higher than that of air, or with an elastically deformable, heat-conducting component whose thermal conductivity is higher than that of air.

### CROSS-REFERENCE TO RELATED APPLICATION

This application is based on German Patent Application 10 2009 029 088.5 filed Sep. 2, 2009.

### BACKGROUND OF THE INVENTION

1. Field of the Invention

The invention is based on a fuel injection assembly.

2. Description of the Prior Art

Diesel engine injection devices, such as injectors, unit fuel injectors, etc., are built into the cylinder head of the diesel engines, and during engine operation they inject the fuel into the combustion chamber. In the process, they more or less rapidly take on the temperatures that occur in the engine compartment. Depending on the way in which they are built in, a more or less wide air gap is located between the injector and the cylinder head, or the cylinder head hood. This air gap prevents the heat transfer between the cylinder head and its attached parts, on the one hand, and the injection device, on the other. In operation, for instance because of pressure reduction at the attached part guides and hydraulic valves, or as a result of the intrinsic heating of the electrical components, the injection device can warm up faster than the air- or water-cooled cylinder head or its attached parts. Particularly in injection devices for high pressures (>1300 bar), damage to the components of the injection device can be caused by the high temperatures that occur.

In DE 102 34 324 A1, the fuel injector is built into an injector bore in the cylinder head. Before the injector is installed, a coolant jacket sleeve is built or inserted into the injector bore in order thereby to form a cooling jacket that surrounds the injector. The coolant jacket sleeve is made from a copper alloy or a corrosion-resistant steel and provides for a better heat transfer, but only if the injector rests with a precise fit with its jacket face on the wall of the injector bore. An annular gap that is otherwise present impairs the heat transfer, and the injector can heat up more strongly than the cooled cylinder head.

### OBJECT AND SUMMARY OF THE INVENTION

By comparison, it is the object of the present invention to improve the temperature transition from the injection device to the forced-cooled cylinder head in such a way that at practically all times, the injection device assumes the temperature of the cooled cylinder head.

According to the invention, an air gap that is otherwise present between the injection device and the cylinder head or its attached parts is filled with a highly heat-conducting liquid (such as heat-conducting paste or oil) whose thermal conductivity is higher than that of air, or with an elastically deformable, heat-conducting component whose thermal conductivity is higher than that of air. As a result, the heat transfer between the injection device and the cylinder head is improved so much that harmful temperatures for the components of the injection device are avoided. In other words, at practically all times, the injection device assumes the temperature of the cooled cylinder head, so that on average, a lower temperature level than would occur without the invention occurs at the injection device. The thermal conductivity of the heat-conducting liquid or of the elastically deformable, heat-conducting component is at least 10 times, and preferably at least 100 times, higher than that of air.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a first exemplary embodiment of the fuel injection assembly of the invention; and

FIG. 2 shows a second exemplary embodiment of the fuel injection assembly of the invention.

### DESCRIPTION OF THE PREFERRED EMBODIMENTS

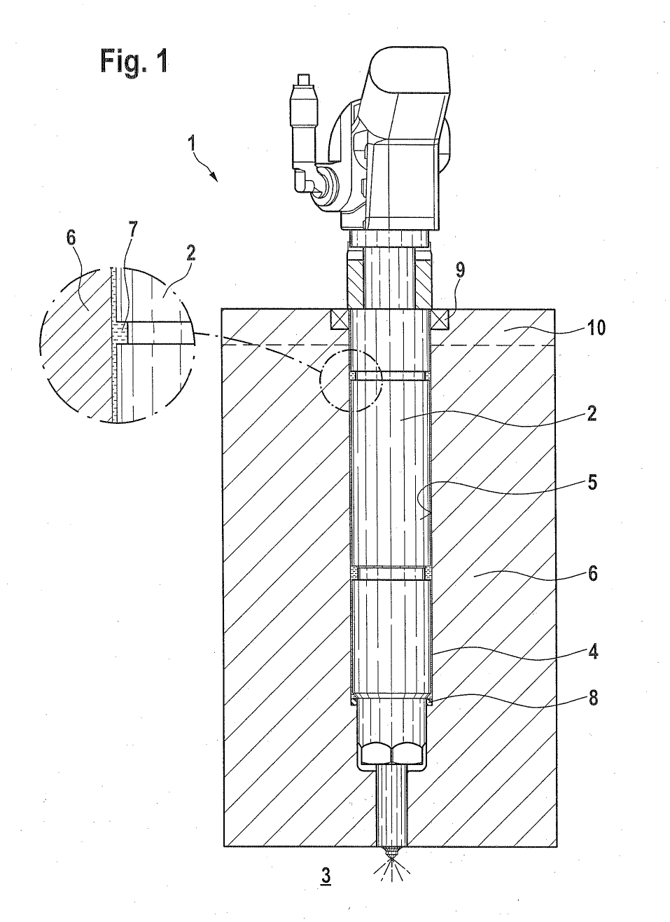

The fuel injection assembly 1, shown schematicey in FIG. 1, of an internal combustion engine includes a fuel injector 2 for injecting fuel into a combustion chamber 3 of the engine. The fuel injector 2 is inserted, forming an annular gap 4, into an injector bore 5 of a cylinder head 6 of the engine and fixed there.

The annular gap 4 is filled over its entire axial length, that is, between its ends toward and away from the combustion chamber, with a heat-conducting liquid (such as oil) or a heat-conducting medium 7 whose thermal conductivity is higher than that of air. The heat transfer from the fuel injector 2 to the cooled cylinder head 6 is improved markedly by this liquid or pastelike heat-conducting medium 7, in comparison to the air gap that is otherwise present, by even the factor of 150 to 400 if heat-conducting paste is used. As a result of the improved cooling of the fuel injector 2, harmful temperatures for the components of the fuel injector 2 are avoided, and the fuel injector 2 assumes the temperature of the cooled cylinder head 6 practically at all times, so that on average, a lesser temperature level occurs at the fuel injector 2 than would occur without the heat-conducting medium 7 filling it.

The annular gap 4, on its end toward the combustion chamber 3, is sealed off from the combustion chamber 3 by a sealing element 8, which is disposed between the fuel injector 2 and the cylinder head 6, so that upon filling of the annular gap, no heat-conducting medium 7 gets into the combustion chamber 3. After the filling with the heat-conducting medium 7, the annular gap 4 is sealed off from the outside, or closed, on its end remote from the combustion chamber 3 by a further sealing element 9 (such as a radial shaft sealing ring, O-ring, etc.).

As indicated in dashed lines in FIG. 1 with a cylinder head hood 10 as an example, the gap 4 may also be embodied between the fuel injector 2 and attached parts of the cylinder head 6.

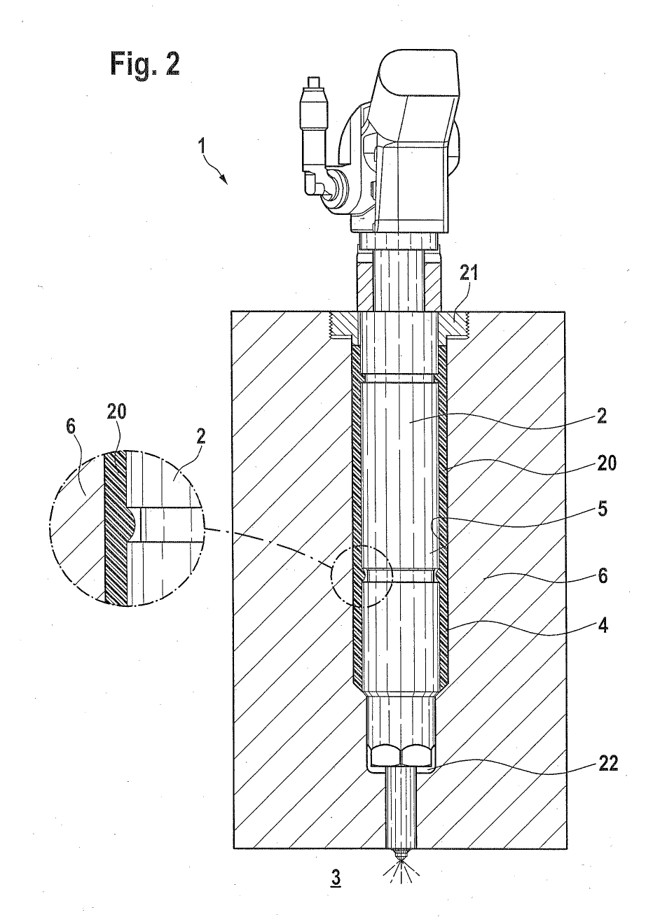

The fuel injection assembly 1 shown in FIG. 2 differs from the exemplary embodiment of FIG. 1 only in that in it, instead of a liquid or pastelike heat-conducting medium 7, a separate component 20 of elastically deformable, heat-conducting material, such as elastomer or silicone, is used. The elastic component 20 is embodied as a sleeve, hose or cuff and is drawn, conforming closely, over part of the injector 2 and then mounted together with the fuel injector 2 in the cylinder head 6. Next, by means of a suitable clamping device, the elastic component 20 is pressed inside the annular gap 4 axially such that in the radial direction, it rests on both the cylinder head 6 and the fuel injector 2 without an air gap. The clamping device may for instance be formed by a collar on the fuel injector 2, by other machine elements, or as shown in FIG. 2, by a screw element 21. By means of the clamping device, the elastic component 20 is pressed axially against a shoulder abutment 22, toward the combustion chamber, of the cylinder head 6, as a result of which, because of its elasticity, it deflects radially and rests on the cylinder head 6 and on the fuel injector 2 without an air gap. The elastic component 20 has a far better thermal conductivity than air. This is the case for instance with elastic materials, such as elastomer or silicone, that have a very high proportion of metal components, such as copper, magnesium, etc.

The foregoing relates to the preferred exemplary embodiments of the invention, it being understood that other variants and embodiments thereof are possible within the spirit and scope of the invention, the latter being defined by the appended claims.

We claim:

1. A fuel injection assembly of an internal combustion engine, having an injection device for injecting fuel into a combustion chamber of the engine, the injection device being built into a cylinder head of the engine and a gap being disposed between the injection device and the cylinder head, or its attached parts, the gap being filled at least partially, preferably entirely, with a heat-conducting liquid whose thermal conductivity is higher than that of air, or with an elastically deformable, heat-conducting component whose thermal conductivity is higher than that of air.

2. The fuel injection assembly as defined by claim 1, wherein the thermal conductivity of the heat-conducting liquid or of the elastically deformable, heat-conducting component, is at least 10 times and preferably at least 100 times higher than that of air.

3. The fuel injection assembly as defined by claim 1, wherein the heat-conducting liquid is an oil or a heat-conducting paste.

4. The fuel injection assembly as defined by claim 2, wherein the heat-conducting liquid is an oil or a heat-conducting paste.

5. The fuel injection assembly as defined by claim 1, wherein the elastically deformable, heat-conducting component is formed of elastic material, in particular of an elastomer or silicone.

6. The fuel injection assembly as defined by claim 2, wherein the elastically deformable, heat-conducting component is formed of elastic material, in particular of an elastomer or silicone.

7. The fuel injection assembly as defined by claim 5, wherein the elastic material of the elastically deformable, heat-conducting component has metal components.

8. The fuel injection assembly as defined by claim 6, wherein the elastic material of the elastically deformable, heat-conducting component has metal components.

9. The fuel injection assembly as defined by claim 5, wherein the elastically deformable, heat-conducting component is embodied as a sleeve, hose or cuff.

10. The fuel injection assembly as defined by claim 6, wherein the elastically deformable, heat-conducting component is embodied as a sleeve, hose or cuff.

11. The fuel injection assembly as defined by claim 7, wherein the elastically deformable, heat-conducting component is embodied as a sleeve, hose or cuff.

12. The fuel injection assembly as defined by claim 8, wherein the elastically deformable, heat-conducting component is embodied as a sleeve, hose or cuff.

13. The fuel injection assembly as defined by claim 1, wherein the heat-conducting liquid, or the elastically deformable, heat-conducting component, is pressed inside the gap.

14. The fuel injection assembly as defined by claim 12, wherein the heat-conducting liquid, or the elastically deformable, heat-conducting component, is pressed inside the gap.

15. The fuel injection assembly as defined by claim 1, wherein the injection device is built into a bore of the cylinder head, or of its attached parts, embodying an annular gap which is filled at least over part of an axial length thereof, and preferably over its entire axial length, with the heat-conducting liquid or with the elastically deformable, heat-conducting component.

16. The fuel injection assembly as defined by claim 14, wherein the injection device is built into a bore of the cylinder head, or of its attached parts, embodying an annular gap which is filled at least over part of an axial length thereof, and preferably over its entire axial length, with the heat-conducting liquid or with the elastically deformable, heat-conducting component.

17. The fuel injection assembly as defined by claim 1, wherein the gap, on its end toward the combustion chamber, is sealed off from the combustion chamber by a sealing element, which is disposed between the fuel injector and the cylinder head.

18. The fuel injection assembly as defined by claim 16, wherein the gap, on its end toward the combustion chamber, is sealed off from the combustion chamber by a sealing element, which is disposed between the fuel injector and the cylinder head.

19. The fuel injection assembly as defined by claim 1, wherein the gap, on its end toward the outside, is sealed off from the combustion chamber by a sealing element, which is disposed between the injection device and the cylinder head.

20. The fuel injection assembly as defined by claim 18, wherein the gap, on its end toward the outside, is sealed off from the combustion chamber by a sealing element, which is disposed between the injection device and the cylinder head.
